(19) United States
(12) Patent Application Publication
(10) Pub. No.: US 2015/0268914 A1
(43) Pub. Date: Sep. 24, 2015

(54) DISPLAY DEVICE

(71) Applicant: SAMSUNG DISPLAY CO., LTD., Yongin-City (KR)

(72) Inventors: Tae-Woong KIM, Yongin-si (KR); Young-Gug SEOL, Hwaseong-si (KR); Ki-Yong LEE, Cheonan-si (KR); Sang-Wol LEE, Yongin-si (KR)

(21) Appl. No.: 14/476,965

(22) Filed: Sep. 4, 2014

(30) Foreign Application Priority Data
Mar. 20, 2014 (KR) 10-2014-0032542

(51) Int. Cl. G06F 3/14; G06F 1/16

(52) U.S. Cl. CPC G06F 3/1423; G06F 1/1652

(57) ABSTRACT

A display device includes a first display, an accommodation unit on a side of the first display, and a second display. The second display is rollably accommodated in the accommodation unit in a rolled state.

### CROSS-REFERENCE TO RELATED APPLICATION

Korean Patent Application No. 10-2014-0032542, filed on Mar. 20, 2014, in the Korean Intellectual Property Office, and entitled: “Display Device,” is incorporated by reference herein in its entirety.

### BACKGROUND

1. Field

Embodiments relate to a display device including one or more displays.

2. Description of the Related Art

There has been a growing focus on development of a flexible display device in which a display panel may be bent. The flexible display device may be provided in a folded or curved form so as to be used in many different areas. The flexible display device includes a display element provided on a flexible substrate. The display element may be an organic light emitting display (OLED), a liquid crystal display (LCD), and an electrophoretic display (EPD), or the like. Among these, the OLED is quite flexible as it can be manufactured to have a thin film laminated structure, and thus the OLED has gained attention as a display element suitable for a flexible display device.

### SUMMARY

Embodiments are directed to a display device including a first display, an accommodation unit on a side of the first display, and a second display. The second display is rollably accommodated in the accommodation unit in a rolled state. The first display may include a flat-panel display substrate. The second display may include a rollable display substrate.

The accommodation unit (container) may include a first cylinder-shaped rotatable housing having an external surface. The accommodation unit may also include a driving unit or driver in the first cylinder-shaped housing, the driver rotatably driving the second display into the rolled state around the external surface of the first housing. The first housing may include a first slot and the driver may be connected to the second display through the first slot. The accommodation unit may include a second housing that provides an area for accommodating the second display in the rolled state around the external surface of the first housing. The second housing may include a second slot through which the second display is drawable from the rolled state.

The second display may include a flexible substrate, a driving circuit on the flexible substrate, a display element or system on the driving circuit, and a thin film encapsulation layer on the display element or system. The display element may include an organic light emitting diode display, a liquid crystal display, or an electrophoretic display. The second display may include a compressive side facing the first housing and a tensile side on the opposite side from the compressive side. A first protective film may be on the tensile side. The first protective film may have a thickness of from about 10 μm to about 100 μm. The second display may include a second protective film on the compressive side, the first protective film having a greater thickness than the second protective film. The second display may have a neutral plane on the display element or the thin film encapsulation layer.

### BRIEF DESCRIPTION OF THE DRAWINGS

Features will become apparent to those of skill in the art by describing in detail exemplary embodiments with reference to the attached drawings in which:

FIG. 1A illustrates a schematic plan view of a rolled second display accommodated in a display device according to an embodiment;

FIG. 1B illustrates a schematic plan view of the spread second display in the display device according to an embodiment;

FIG. 2 illustrates a schematic cross-sectional view of an accommodation unit of the display device;

FIG. 3 illustrates a schematic cross-sectional view of the second display of the display device according to an embodiment;

FIG. 4 illustrates a schematic cross-sectional view of an external force applied on the second display of the display device;

FIG. 5 illustrates a schematic cross-sectional view of a second display of a display device according to an embodiment;

FIG. 6 illustrates a schematic cross-sectional view of a second display of a display device according to another embodiment;

FIG. 7 illustrates a graph of a luminance variation of a second display of a display device according to an embodiment, where a protective film is not included;

FIG. 8 illustrates a graph of a luminance variation of a second display of a display device according to an embodiment, where a protective film is included.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawing figures, the dimensions of layers and regions may be exaggerated for clarity of illustration. Like reference numerals refer to like elements throughout. Although the terms “first,” “second,” “third,” and the like may be used herein to describe various elements, these elements should not be limited by these terms. These terms are only used to distinguish one element from another element.

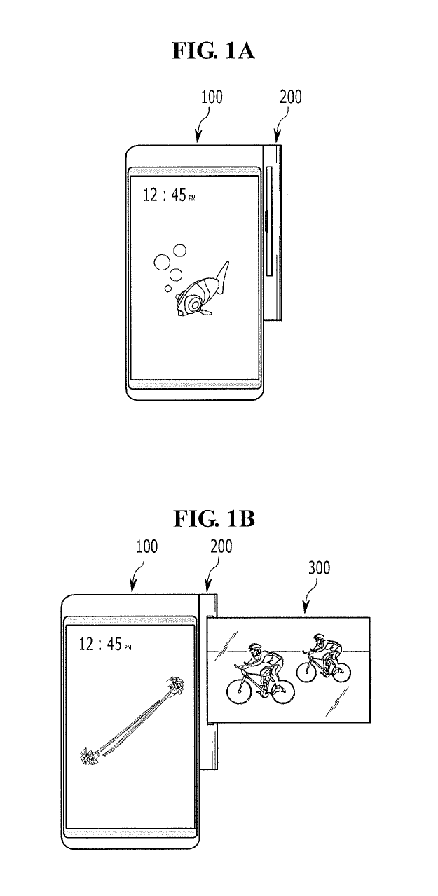

FIGS. 1A and 1B illustrate plan views showing a display device according to an embodiment. FIG. 1A illustrates a schematic plan view showing a second display 300 rolled and accommodated in the display device, and FIG. 1B illustrates a schematic plan view showing the second display 300 spread out in the display device. In FIGS. 1A and 1B, for example, the display device includes a first display 100, an accommodation unit 200, and the second display 300.

The first display 100 may include a flat panel display substrate. The accommodation unit 200 in the form of a container may be on one side of the display 100. The second display 300 may be rolled and accommodated in the accommodation unit 200 (FIG. 1A), or spread out from the accommodation unit 200 (FIG. 1B). The second display 300 may include a rollable display substrate. In FIGS. 1A and 1B, for example, the display device may be a smartphone. Various other display devices may be used. The same image may be displayed on both of the first display 100 and the second display 300, and different images may be displayed on the first display 100 and the second display 300, respectively.

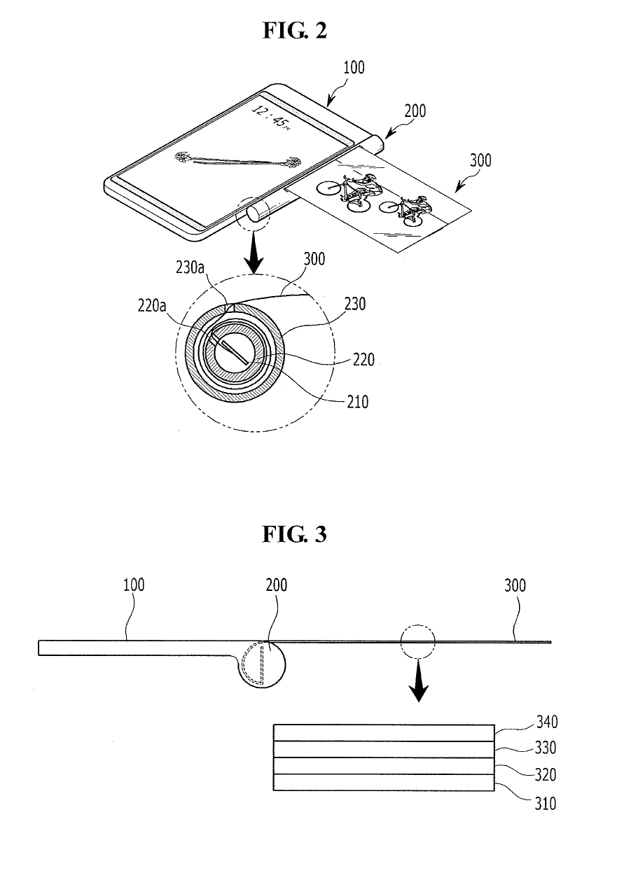

FIG. 2 illustrates a schematic cross-sectional view showing the accommodation unit of the display device according to an embodiment. In FIG. 2, for example, the accommodation unit 200 includes a driving unit or driver 210, a first housing 220, and a second housing 230. The driver 210 may be connected to an end of the second display 300, and may supply various driving powers and driving signals to the second display 300 for driving the second display 300.

The first housing 220 may include the driver 210 inside the first housing 220 and a first slot 220a for inserting the second display 300. The second display 300 may be spread out from the inside of the first housing 220 and rolled around an external surface of the first housing 220. The first housing 220 may be provided in a shape of a cylinder and be rotatable. The first housing 220 may be rotated using a motor or by hand to roll up or spread out the second display 300.

The second display 300 may have a prestress. When an external force is not applied on the display 300, for example, the second display 300 may maintain a state of being rolled. When the external force is applied, for example, the second display 300 may be spread. When the applied external force is stopped, for example, the second display 300 may be rolled back.

The second housing 230 may include the first housing 220 and an accommodation unit area for the second display 300 rolled around the external surface of the first housing 220. The second housing 230 may further include the second slot 220a to withdraw the second display 300 accommodated therein to the outside.

An end of the second display 300 may be connected to the driver 210. The display 300 may pass through the first slot 220a of the first housing 220, and may be rolled around the external surface of the first housing 220 or may be spread out to the outside through a second slot 230a of the second housing 230. The thickness of the other end of the second display 300 may be larger than the width of the second slot 230a. The other end of the second display 300 may become attached to the outside of the second housing 230, for example, when rolled back.

FIG. 3 illustrates a schematic cross-sectional view of the second display of the display device according to an embodiment. In FIG. 3, for example, the second display 300 includes a flexible substrate 310, a driving circuit 320 on the flexible substrate 310, a display element or system 330 on the driving circuit 320, and a thin film encapsulation layer 340 on the display element 330.

The flexible substrate 310 may include a flexible material. Such a flexible material may include plastic materials. The flexible substrate 310 may include one or more of a polyethersulphone (PES), a polycarbonate (PC), a polyimide (PI), a polyethyleneterephthalate (PET), a polyethylenenaphthalate (PEN), a polyacrylate (PAR), and a fiber reinforced plastic (FRP). Polyimides may exhibit high thermal resistivity, useful when the flexible substrate 310 is subject to high-temperature processes. For example, the polyimide may include a KAPTON® film.

The flexible substrate 310 may have a thickness of from about 5 μm to about 200 μm. When the flexible substrate 310 has a thickness less than 5 μm, for example, the flexible substrate 310 might not stably support the display element 330. When the flexible substrate 310 has a thickness more than 200 μm, for example, flexibility may be reduced. The flexible substrate 310 may have a coefficient of expansion (CTE) of from about 3 ppm/° C. to about 10 ppm/° C.

The driving circuit 320 may supply a driving power and various driving signals to the display element 330, and may be in a form of a thin film transistor TFT. The display element 330 may be one of an organic light emitting diode, a liquid crystal display (LCD), and an electrophoretic display (EPD).

The thin film encapsulation layer 340 may include one or more inorganic layers and one or more organic layers. The thin film encapsulation layer 340 may have a structure in which the inorganic layers and the organic layers are alternately laminated. The inorganic layer may be at the bottom. The inorganic layer may be closest to the display element 330. The thin film encapsulation layer 340 may have a thickness of about 10 μm or less.

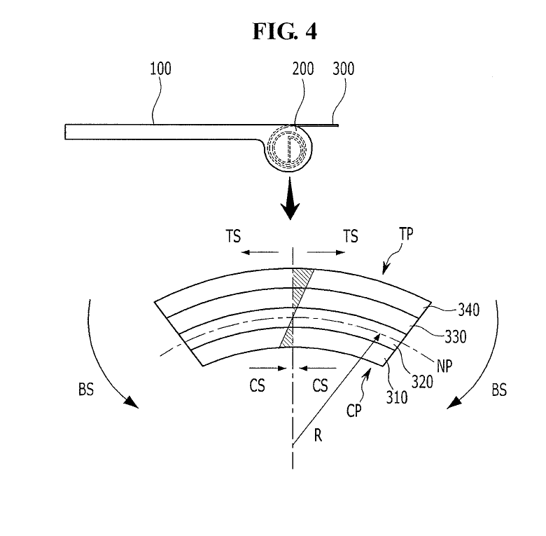

FIG. 4 illustrates a cross-sectional view depicting the external force applied on the second display of the display device. FIG. 4 illustrates various stresses that may be caused, for example, when the second display is rolled in the accommodation unit 200. The stress refers to resistive force or transformation stress produced in an object due to an external force applied on the object. The stress becomes larger as the external force increases. The capability of the object to endure stress may be limited, and thus the object may be destroyed, for example, when subjected to eigen-yield stress. An object having large eigen-yield stress may have great rigidity. A stress magnitude may be expressed as a magnitude of the external force per unit area, referred to as unit stress. Hereinafter, the stress refers to unit stress, unless stated otherwise. When the second display 300 is repeatedly rolled or spread, for example, the second display 300 might be damaged.

In FIG. 4, when the second display 300 is rolled or spread, for example, different bending stresses BS may be caused inside the second display 300. When the second display 300 is rolled, with respect to a neutral plane NP, for example, tensile stress TS may be caused on a tensile plane TP on one side of the second display 300, and compressive stress CS may be caused on a compressive plane CP on the other side of the second display 300. The neutral plane NP refers to a plane that may maintain the original length without shrinking or stretching, for example, when an object is subjected to a force and bent. The position of the neutral plane NP may be determined based on a thickness and an elastic modulus of each layer composing the second display 300.

When the second display 300 is rolled, for example, stress may be caused on each layer composing the second display 300. With respect to a neutral plane NP, the tensile stress TS may be on an upper portion of the driving circuit 320, the display element 330, and the thin film encapsulation layer 340. The compressive stress CS may be on the bottom portion of the driving circuit 320 and the flexible substrate 310. As the layer is located farther from the neutral plane NP, the tensile stress TS and the compressive stress CS may be increased.

When the second display 300 has prestress, for example, the compressive stress CS may be on the display element 330 and the thin film encapsulation layer 340, while the tensile stress TS may be on the bottom portion of driving circuit 320 and the flexible substrate 310. When the stresses are repeatedly applied on the second display 300 or the bending stress BS above the endurance limit is applied, for example, the element, such as the thin film transistor TFT on the driving circuit 320 on the second display 300 may be damaged or the conduction line may be disconnected. When the thin film encapsulation layer 340 is damaged, for example, moisture may infiltrate into the thin film encapsulation layer 340 and cause damage on the display element 330 or the driving circuit 320.

As the bending stress BS applied on the second display 300 increases, a radius of curvature R of the second display 300 may be reduced. The radius of curvature R of the second display 300 is proportional to a diameter of the accommodation unit 200. As the radius of curvature R of the second display 300 becomes smaller, the size of the accommodation unit 200 may be made smaller. As the radius of curvature R of the second display 300 becomes smaller, the bending stress BS on the second display 300 may be increased, and thus the second display 300 may be more easily damaged. There may be a trade-off relationship between the diameter of the accommodation unit 200, reflecting the portability of the display device, and the rigidity of the second display 300. A structure capable of reducing the radius of curvature R of the second display 300 and at the same time maintaining the rigidity of the second display 300 is provided.

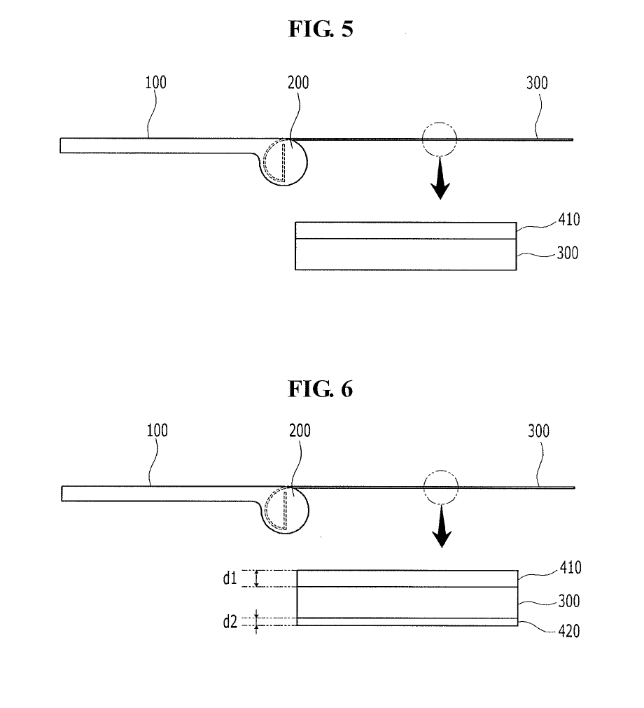

FIG. 5 illustrates a schematic cross-sectional view showing the second display of a display device according to an embodiment. In FIG. 5, for example, the second display 300 may include a protective film 400 disposed on the tensile plane TP of the second display 300. The protective film 400 may have a thickness of from about 10 μm to about 100 μm. The protective film 400 may include, for example, a transparent material; however, the protective film 400 may be semi-transparent or colored, where applicable. Further, the protective film 400 may include a flexible material. The protective film 400 may include one or more of a polyester film, a polyethylene film, a polypropylene film, a triacetyl cellulose film, a polyvinyl chloride film, a polyvinyl alcohol film, a polyimide film, a cycloolefin resin film, a polycarbonate film, a polyethylene terephthalate film, a polyethylene naphthalate film, a polyether sulfone film, a polyimide film, an epoxy resin films, a phenolic resin films, a melamine resin film, a polyurethane film, and an acrylic resin film.

According to an embodiment, the neutral plane NP may be located on the display element 330, the driving circuit 320, or an area adjacent thereto in the second display 300. Although the second display 300 may be bent, the bending stress BS applied on the display element 330 or the driving circuit 320 is reduced, such that damage inflicted thereon may be prevented.

When a flat member including one material is used, for example, the neutral plane NP may be located at the center of the width of the flat member. When a flat member including various laminated materials is used, the neutral plane NP might not be located at the center of the width of the flat member. Even when the neutral plane NP is not located at the center of the width of the flat member, for example, provided that the different materials do not have much different physical properties, the neutral plane NP may be located adjacent to the center of the width of the flat member.

The protective film 400 may be on the tensile plane TP of the second display 300, such that the bending stress BS on the second display 300 may be reduced. When the protective film 400 having a thickness of from about 10 μm to about 100 μm is on the tensile plane TP of the second display 300, for example, the position of the neutral plane NP may be moved from the driving circuit 320 to the thin film encapsulation layer 340, and the compressive stress CS may be on the driving circuit 320, such that the radius of curvature of the second display 300 may be reduced. The protective film may be on the tensile plane TP of the second display 300, such that the radius of curvature R of the second display 300 may be reduced and at the same time the rigidity of the second display 300 may be maintained.

FIG. 6 illustrates a schematic cross-sectional view showing a second display of a display device according to another embodiment. In FIG. 6, for example, the second display 300 includes a first protective film 410 on the tensile plane TP of the second display 300 and a second protective film 420 on the compressive plane CP of the second display 300.

The first protective film 410 and the second protective film 420 may have a thickness from about 10 μm to about 100 μm. A thickness d1 of the first protective film 410 may be larger than a thickness d2 of the second protective film 420. In the second display 300 of another embodiment, the thickness of the first protective film 410 on the tensile plane TP may be larger than the thickness of the second protective film 420 on the compressive plane CP, such that the bending stress BS on the second display 300 may be reduced.

The thickness of the first protective film 410 may be larger than the thickness of second protective film 420, and thus the position of the neutral plane NP may be moved from the driving circuit 320 to the thin film encapsulation layer 340, such that the compressive stress CS is on the driving circuit 320 and the radius of curvature R of the second display 300 may be reduced. According to another embodiment, the thickness of the first protective film 410 may be larger than the thickness of the second protective film 420, such that the radius of curvature R of the second display 300 may be reduced and at the same time the rigidity of the second display 300 may be maintained.

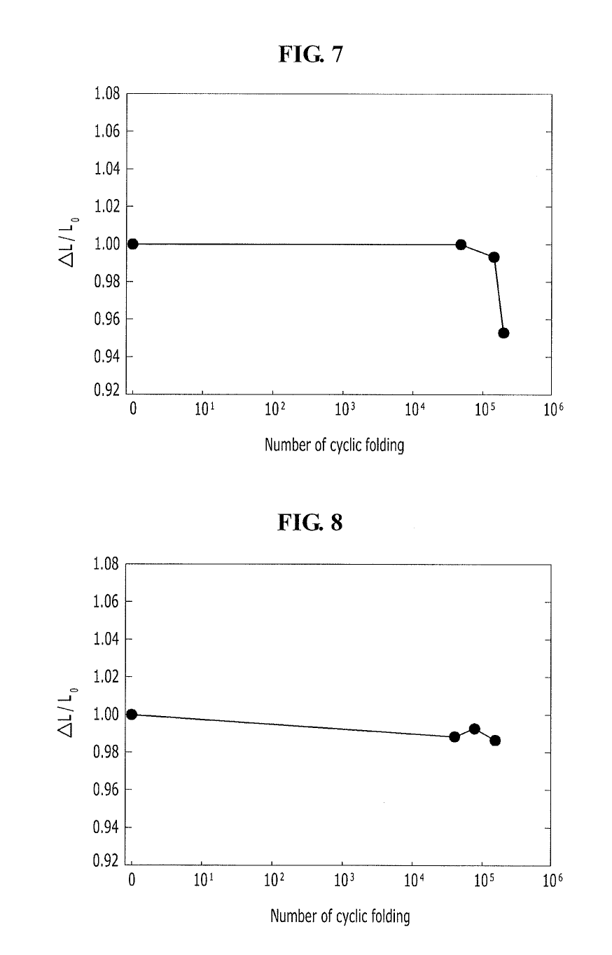

FIG. 7 illustrates a graph of a luminance variation of a second display according to an embodiment, in which a protective film is not included, and FIG. 8 illustrates a graph of a luminance variation of a second display according to an embodiment, in which a protective film is included. The x-axis represents the number of cyclic folding, and y-axis represents luminance variation ΔL with respect to an initial luminance L0. In FIG. 7, in the second display according to an embodiment, in which the protective film is not provided, the luminance of the second display rapidly drops, as the number of cyclic folding increases. Referring to FIG. 8, in the second display according to an embodiment, in which the protective film is provided, the second display maintains the luminance level, although the number of cyclic folding increases.

By way of summation and review, various methods have been used for mounting two or more displays on a display device. With recent developments in communication and image technology, there has been an increase in demand for a portable display device including a large-size display unit. There are methods for mounting two or more displays on a display device, including, for example, methods of physically coupling multiple display units, for example, in a folded form. Such methods can provide the large-size display unit; however, an area for the display device may be doubled, such that portability is reduced.

According to embodiments disclosed herein, a display device includes a rolling display along with a fixed display unit, such that the display device can provide a large-size display area and be easily carried. According to embodiments, the display device may further reduce bending stress, caused, for example, when the display substrate is rolled, by adjusting the thickness of a protective film on the display substrate.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A display device comprising:
a first display;
an accommodation unit on a side of the first display; and
a second display rollably accommodated in the accommodation unit in a rolled state.

2. The display device as claimed in claim 1, wherein the first display includes a flat-panel display substrate.

3. The display device as claimed in claim 1, wherein the second display includes a rollable display substrate.

4. The display device as claimed in claim 2, wherein the accommodation unit includes:
a first rotatable cylinder-shaped housing having an external surface;
an external surface; and
a driver in the first cylinder-shaped housing, the driver rotatably driving the second display into the rolled state around the external surface of the first housing.

5. The display device as claimed in claim 4, wherein the first housing includes a first slot and the driver is connected to the second display through the first slot.

6. The display device as claimed in claim 4, wherein the accommodation unit includes a second housing that provides an area for accommodating the second display in the rolled state around the external surface of the first housing.

7. The display device as claimed in claim 6, wherein the second housing includes a second slot through which the second display is drawable from the rolled state.

8. The display device as claimed in claim 1, wherein the second display includes:
a flexible substrate;
a driving circuit on the flexible substrate;
a display element on the driving circuit; and
a thin film encapsulation layer on the display element.

9. The display device as claimed in claim 8, wherein the display element includes an organic light emitting diode display, a liquid crystal display, or an electrophoretic display.

10. The display device as claimed in claim 8, wherein the second display includes:
a compressive side facing the first housing and a tensile side on the opposite side from the compressive side; and
a first protective film on the tensile side.

11. The display device as claimed in claim 10, wherein the first protective film has a thickness of from about 10 μm to about 100 μm.

12. The display device as claimed in claim 10, wherein the second display has a neutral plane on the display element or the thin film encapsulation layer.

13. The display device as claimed in claim 10, wherein the second display includes a second protective film on the compressive side, the first protective film having a greater thickness than the second protective film.

14. The display device as claimed in claim 13, wherein the second display has a neutral plane on the display element or the thin film encapsulation layer.
